(19) United States
(12) Patent Application Publication
(10) Pub. No.: US 2015/0021298 A1
(43) Pub. Date: Jan. 22, 2015

(54) SWITCHGEAR

(71) Applicant: Hitachi, Ltd., Tokyo (JP)

(72) Inventors: Masashi SAWADA, Tokyo (JP); Daisuke SUGAI, Tokyo (JP)

(21) Appl. No.: 14/334,245

(22) Filed: Jul. 17, 2014

(30) Foreign Application Priority Data
Jul. 19, 2013 (JP) 2013-150235

(51) Int. Cl. H01H 33/666; H01H 31/00

(52) U.S. Cl. CPC H01H 33/6661; H01H 31/003; H01H 2033/6667
USPC 218/140

(57) ABSTRACT

Switchgear comprising: an air-insulated earthing disconnecting switch switchable among the closing position, disconnecting position, and earthing position; a vacuum interrupter electrically connected to the air-insulated earthing disconnecting switch; an operating device of the air-insulated earthing disconnecting switch having a motor; and an operating-force transmission unit transmitting driving force from the motor to a movable electrode of the air-insulated earthing disconnecting switch, wherein the operating-force transmission unit includes an operation rod fixedly coupled to the movable electrode, a shaft rotatably driven by the motor, a lever fixed to the shaft and making an arc motion with the shaft rotatably driven, a coupling pin coupling the lever and the operation rod, and limit switches detecting that the air-insulated earthing disconnecting switch is in the closing position, disconnecting position, or earthing position by means of the coupling pin driven by the operation of the rod operating with an arc motion of the lever.

### CLAIM OF PRIORITY

The present application claims priority from Japanese Patent application serial no. 2013-150235, filed on Jul. 19, 2013, the content of which is hereby incorporated by reference into this application.

### TECHNICAL FIELD

This invention relates to switchgears and is particularly suitable for switchgears having an air-insulated earthing disconnecting switch that performs closing, disconnecting, and earthing operations with air insulation.

### BACKGROUND ART

Japanese Unexamined Patent Application Publication No. 2011-41407 (Patent Literature 1) discloses an example of typical switchgears that include an air-insulated earthing disconnecting switch performing closing, disconnecting, and earthing operations with air insulation, but are still compact even though employing air insulation.

This switchgear disclosed in the Patent Literature 1 includes an air-insulated earthing disconnecting switch that linearly moves and is switchable among three positions, i.e., a closing position, a disconnecting position, and an earthing position, a vacuum interrupter that applies or interrupts voltage and current in a vacuum chamber maintained under vacuum, and a solid insulator that encloses the air-insulated earthing disconnecting switch and the vacuum interrupter. The switchgear is also characterized in that the air-insulated earthing disconnecting switch is electrically connected to the vacuum interrupter, and application and interruption of voltage and current are performed inside the vacuum interrupter.

In addition, the switchgear described in the Patent Literature 1 is operated as follows: application of voltage and current to a high-voltage circuit, such as a cable, is made by closing the vacuum interrupter after the air-insulated earthing disconnecting switch is brought into conduction; interruption of voltage and current is made by opening the vacuum interrupter while the air-insulated earthing disconnecting switch is in conduction; disconnection of the high-voltage circuit is made by switching the air-insulated earthing disconnecting switch to the disconnecting position after voltage and current are interrupted; and earthing of the high-voltage circuit is made by switching the air-insulated earthing disconnecting switch to the earthing position after the high-voltage circuit is disconnected, and then closing the vacuum interrupter.

### CITATION LIST

### Patent Literature

[Patent Literature 1] JP-A No. 2011-41407

### SUMMARY OF INVENTION

### Technical Problem

However, the switchgear as disclosed in the aforementioned Patent Literature 1 is configured so that the accuracy of three positions for closing, disconnecting, and earthing, more specifically, the dimensional accuracy of a gap between contacts at the closing, disconnecting, and earthing positions, affects insulation performance. Thus, further study on control is needed to improve the dimensional accuracy of a gap between the contacts.

The present invention has been made in view of the above points and provides a switchgear that has improved stopping accuracy at three positions, i.e., a closing position, a disconnecting position, and an earthing position, thereby stabilizing insulation performance.

### Solution to Problem

The switchgear according to the invention includes an air-insulated earthing disconnecting switch that linearly moves and is switchable among a closing position, a disconnecting position, and an earthing position, a vacuum interrupter that is electrically connected to the air-insulated earthing disconnecting switch and makes and breaks current flow in a vacuum chamber maintained under vacuum, and an operating device that provides driving force to movable electrodes of the air-insulated earthing disconnecting switch and the vacuum interrupter. The air-insulated earthing disconnecting switch and the vacuum interrupter are integrally covered with a solid insulation. The operating device of the air-insulated earthing disconnecting switch transmits driving force from a motor to the air-insulated earthing disconnecting switch via an operating-force transmission unit. The operating-force transmission unit includes an operation rod fixedly coupled to the movable electrode of the air-insulated earthing disconnecting switch, a lever making an arc motion with a shaft rotatably driven by the motor, a coupling pin coupling the lever and the operation rod, and limit switches detecting that the air-insulated earthing disconnecting switch is in the closing position, disconnecting position, or earthing position by means of the coupling pin driven by the operation of the rod operating with an arc motion of the lever.

### Advantageous Effects of Invention

The present invention can provide a switchgear that has improved stopping accuracy at three positions, i.e., a closing position, a disconnecting position, and an earthing position, thereby stabilizing insulation performance.

### BRIEF DESCRIPTION OF DRAWINGS

FIG. 1 is a schematic diagram showing the configuration of a switchgear according to an embodiment of the present invention;

FIG. 2 is a schematic diagram showing details of an operating-force transmission unit of an air-insulated earthing disconnecting switch of the switchgear according to the embodiment of the invention;

FIG. 3 is a perspective view showing details of the operating-force transmission unit of the air-insulated earthing disconnecting switch of the switchgear according to the embodiment of the invention; and

FIG. 4 is a front view of FIG. 3.

### DESCRIPTION OF EMBODIMENTS

With reference to an illustrated embodiment, a switchgear according to the embodiment of the present invention will be described below.

### Embodiment

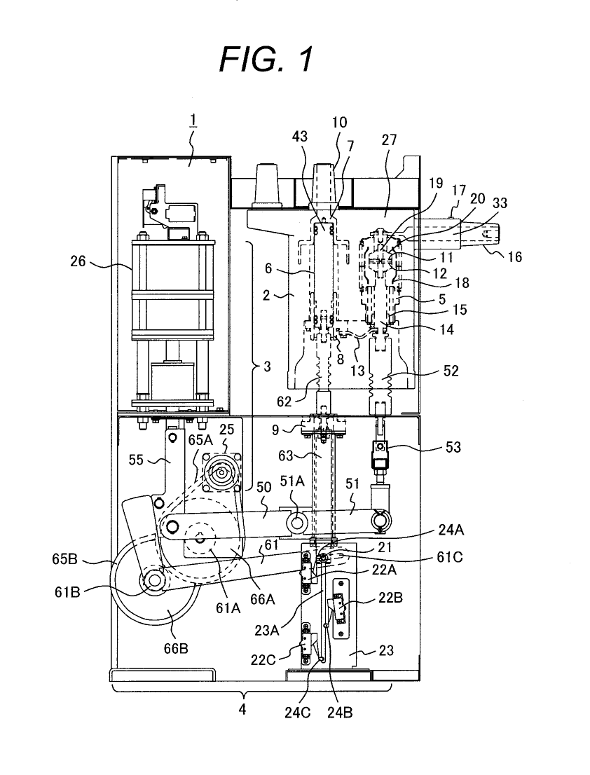

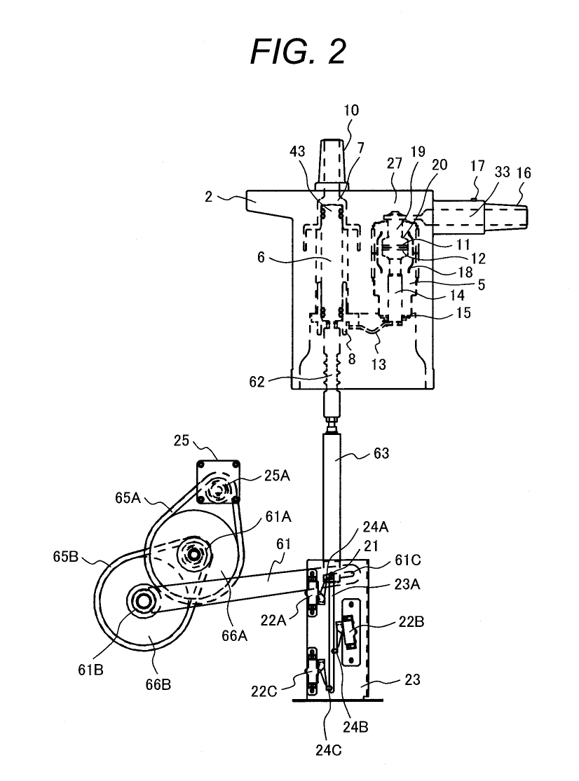

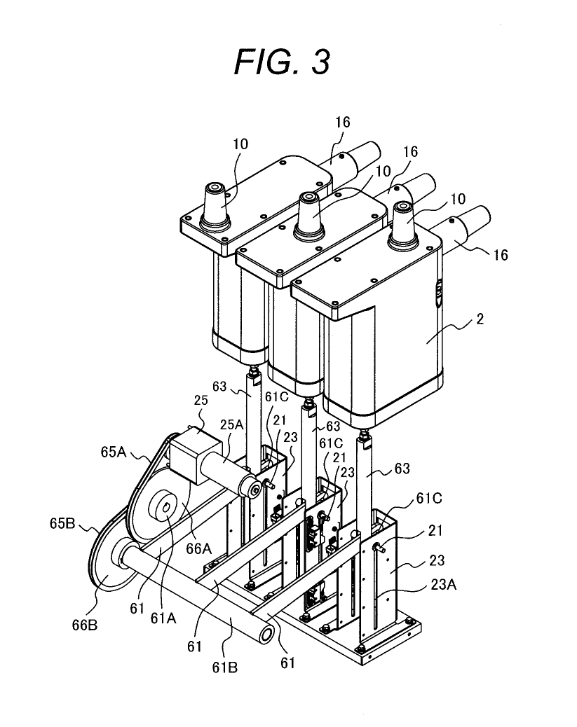

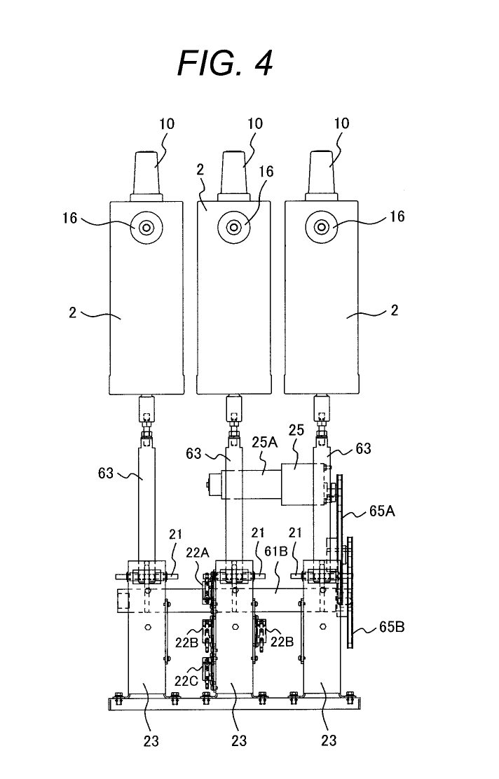

FIGS. 1 to 4 show a vacuum insulated switchgear which is a switchgear according to the embodiment of the invention.

As shown in FIGS. 1 to 4, the vacuum insulated switchgear 1 of the embodiment mainly includes a mold switch 2, an operating device 3, and an operating-force transmission unit 4. The following are descriptions of those inclusions.

The mold switch 2 includes a vacuum interrupter 5 having the functions of closing and breaking in vacuum insulation and a three-position air-insulated earthing disconnecting switch 6 having the functions of closing, disconnecting, and earthing. The interrupter 5 and switch 6 are covered with a solid insulator 27 of epoxy or the like. The vacuum interrupter 5 is electrically connected to the air-insulated earthing disconnecting switch 6 with a flexible conductor 13.

The air-insulated earthing disconnecting switch 6 has a first fixed electrode 7 that is connected to a busbar-side conductor (not shown) in a busbar mold bushing 10 connected to a busbar. The air-insulated earthing disconnecting switch 6 has a second fixed electrode 8 that is connected to a movable conductor 14 of the vacuum interrupter 5 through the flexible conductor 13 connected therebetween. Furthermore, the air-insulated earthing disconnecting switch 6 has a third fixed electrode 9 that is earthed.

The inner circumferences of the first fixed electrode 7, second fixed electrode 8, and third fixed electrode 9 of the air-insulated earthing disconnecting switch 6 are aligned along the same cylinder. An air movable electrode 43 in a shape corresponding to the cylinder slides along the inner circumferences of the respective fixed electrodes. The air movable electrode 43 is connected to an air-insulated operation rod 62 made from an insulating member. This air-insulated operation rod 62 is connected to an operation rod 63 linked to the operating device 3.

The vacuum interrupter 5 includes a fixed electrode 11, a movable electrode 12 facing the fixed electrode 11, a fixed conductor 19 connected to the fixed electrode 11, and a movable conductor 14 connected to the movable electrode 12. The fixed electrode 11 and movable electrode 12 are surrounded by an arc shield 18 to prevent a vacuum chamber 20 from being damaged by arc vapor.

In the vacuum interrupter 5, a vacuum chamber 20 is maintained under vacuum. A bellows 15 provided between the vacuum chamber 20 and the movable conductor 14 allows the movable conductor 14 to operate while maintaining the vacuum chamber 20 under vacuum. The fixed conductor 19 is connected to a feeder conductor 33 that has an end provided with a mold bushing 16 molded with an insulation material. In addition, a voltage detector 17 is connected to a middle part of the feeder conductor 33 to make it possible to measure voltage to be applied to a load. Outside of the vacuum chamber 20, the movable conductor 14 is connected to the flexible conductor 13, which is connected to the second fixed electrode 8 of the air-insulated earthing disconnecting switch 6, and also is connected to an air-insulated operation rod 52, which is made from an insulating member and used with the vacuum interrupter 5. The air-insulated operation rod 52 is connected to an operation rod 53 for the vacuum interrupter 5, disposed on the side of the operating-force transmission unit 4.

The busbar-side conductor (not shown) in the busbar mold bushing 10, the first fixed electrode 7 and the second fixed electrode 8 of the air-insulated earthing disconnecting switch 6, the vacuum chamber 20 and the feeder conductor 33 are integrally molded with an insulation material of epoxy or the like, which forms the solid insulator 27. Further, the solid insulator 27 is formed to surround the air-insulated operation rods 52, 62 with a space therebetween. However, the flexible conductor 13 is not molded with the insulation material to maintain its flexibility. The flexibility of the flexible conductor 13 permits the movable conductor 14 that is connected to the second fixed electrode 8 of the air-insulated earthing disconnecting switch 6 to move in an axis direction.

The following describes the operating device 3. The operating device 3 includes a motor 25 playing a role of an operating instrument for the air-insulated earthing disconnecting switch 6 and an operating instrument 26 for the vacuum interrupter 5. The motor 25 provides driving force to the air movable electrode 43 in the air-insulated earthing disconnecting switch 6, while the operating instrument 26 provides driving force to the movable electrode 12 in the vacuum interrupter 5.

Next, the operating-force transmission unit 4 will be described. The operating-force transmission unit 4 is broadly divided into a part on the vacuum interrupter 5 side and apart on the air-insulated earthing disconnecting switch 6 side.

First, the operating-force transmission unit 4 on the vacuum interrupter 5 side includes an operating-instrument-side rod 55 connected to the operating instrument 26, a main lever 50 connected to the operating-instrument-side rod 55, a shaft (pivot) 51A connected to the main lever 50, three-phase levers 51 connected to the shaft 51A, and three-phase operation rods 53 respectively connected to the three-phase levers 51. Each operation rod 53 is connected to the air-insulated operation rod 52 on the vacuum interrupter 5 side.

The operating-force transmission unit 4 on the air-insulated earthing disconnecting switch 6 side includes a first chain 65A linked to a rotating shaft 25A of the motor 25, a first gear 66A engaged with the first chain 65A to transmit the rotational energy of the motor 25 to a shaft 61A, a second chain 65B linked to the shaft 61A, a second gear 66B engaged with the second chain 65B to transmit the rotational energy from the shaft 61A to an extended shaft 61B, three-phase levers 61 connected to the extended shaft 61B and performing an arc motion, three-phase operation rods 63 respectively connected to the three-phase levers 61, and coupling pins 21 respectively coupling each of the three-phase operation rods 63 to the corresponding lever of the three-phase levers 61.

In addition, the operating-force transmission unit 4 on the air-insulated earthing disconnecting switch 6 side according to the embodiment includes a closing-position detecting limit switch 22A, a disconnecting-position detecting limit switch 22B, and an earthing-position detecting limit switch 22C. The rotational motion generated by the motor 25 is transmitted to the extended shaft 61B via the first chain 65A, first gear 66A, second chain 65B, and second gear 66B and causes the three-phase levers 61 coupled to the extended shaft 61B to perform an arc motion. The arc motion actuates the operation rod 63 and resultantly drives the coupling pin 21 to allow the aforementioned limit switches to detect that the air-insulated earthing disconnecting switch 6 is in the closing position, disconnecting position, or earthing position.

The closing-position detecting limit switch 22A, disconnecting-position detecting limit switch 22B, and earthing-position detecting limit switch 22C are attached to a U-shaped guide hardware 23 that is disposed so as to surround the coupling part where one of the three-phase levers 61 and one of the three-phase operation rods 63 is coupled by the coupling pin 21. The U-shaped guide hardware 23 has first slotted holes 23A extending in a vertical direction formed in the side walls opposite to each other. The coupling pin 21 moves in the first slotted holes 23A in the vertical direction and comes into contact with the closing-position detecting limit switch 22A, disconnecting-position detecting limit switch 22B, and earthing-position detecting limit switch 22C, respectively arranged at positions corresponding to the closing position, disconnecting position, and earthing position of the air-insulated earthing disconnecting switch 6, thereby detecting that the air-insulated earthing disconnecting switch 6 is in the closing position, disconnecting position, or earthing position.

In addition, each of the three-phase levers 61 has an end with a second slotted hole 61C extending in a longitudinal direction of each of the three-phase levers 61. The coupling pin 21 moves in the second slotted hole 61C operatively associated with the arc motion of each of the three-phase levers 61 and also moves in the first slotted holes 23A in the vertical direction, thereby causing the operation rod 63 to move vertically.

Furthermore, one closing-position detecting limit switch 22A and one earthing-position detecting limit switch 22C are disposed at positions corresponding to the closing position and earthing position of the air-insulated earthing disconnecting switch 6, respectively, while two disconnecting-position detecting limit switches 22B are disposed at positions corresponding to the disconnecting position of the air-insulated earthing disconnecting switch 6.

More specifically, the closing-position detecting limit switch 22A disposed at a position corresponding to the closing position of the air-insulated earthing disconnecting switch 6 is arranged at an upper part of the U-shaped guide hardware 23. The disconnecting-position detecting limit switches 22B disposed at positions corresponding to the disconnecting position of the air-insulated earthing disconnecting switch 6 are arranged at the center of both the side walls of the U-shaped guide hardware 23, respectively. The earthing-position detecting limit switch 22C disposed at a position corresponding to the earthing position of the air-insulated earthing disconnecting switch 6 is arranged at a lower part of the U-shaped guide hardware 23.

In addition, in the vicinity of the first slotted holes 23A around which the closing-position detecting limit switch 22A, disconnecting-position detecting limit switch 22B, and earthing-position detecting limit switch 22C for the air-insulated earthing disconnecting switch 6 are disposed, rollers 24A, 24B, 24C are set as integral parts of the limit switches, respectively. When the coupling pin 2l makes contact with the rollers 24A, 24B, 24C, the rollers push to actuate the closing-position detecting limit switch 22A, disconnecting-position detecting limit switch 22B, and earthing-position detecting limit switch 22C disposed at positions corresponding to the closing, disconnecting, earthing positions of the air-insulated earthing disconnecting switch.

According to the embodiment, the coupling pin 21 attached to the operation rod 63 pushes the closing-position detecting limit switch 22A when the air-insulated earthing disconnecting switch 6 is in the closing position, pushes the disconnecting-position detecting limit switch 22B when the air-insulated earthing disconnecting switch 6 is in the disconnecting position, and pushes the earthing-position detecting limit switch 22C when the air-insulated earthing disconnecting switch 6 is in the earthing position, thereby detecting the each position of the air-insulated earthing disconnecting switch 6.

In addition, a brake command is issued to the motor 25 in synchronization with a press of one of the closing-position detecting limit switch 22A, disconnecting-position detecting limit switch 22B, and earthing-position detecting limit switch 22C for the air-insulated earthing disconnecting switch 6, thereby stopping the motor 25.

During the time from the moment a limit switch is turned on until a brake command reaches the motor 25, the motor 25 keeps running and also the coupling pin 21 keeps moving. By employing a reduction gear designed to rotate at a lower speed than the motor 25 to reduce the amount of movement of the coupling pin 21 from when the closing-position detecting limit switch 22A, disconnecting-position detecting limit switch 22B, and earthing-position detecting limit switch 22C are turned on to when the brake command reaches the motor 25, the coupling pin 21 can be controlled to stop at positions for closing, disconnecting, and earthing with high accuracy.

The coupling pin 21 is configured so as to be capable of moving downward at the closing position, both upward and downward at the disconnecting position, and upward at the earthing position.

Since the disconnecting-position detecting limit switch 22B adopts a roller mechanism that allows the coupling pin 21 to pass by both upwardly and downwardly, the coupling pin 21 presses in the disconnecting-position detecting limit switch 22B at different positions between when the coupling pin 21 moves from above to below and from below to above. More specifically, the coupling pin 21 pressed down from above pushes the roller 24B at a different position from the position at which the coupling pin 21 pressed up from below pushes the roller 24B. Because of this, two disconnecting-position detecting limit switches 22B are provided to separately detect the coupling pin 21 moving from above to below and from below to above in order to control the stop position of the coupling pin 21 to be the same in both directions.

Although the timing of pressing the closing-position detecting limit switch 22A, disconnecting-position detecting limit switch 22B, and earthing-position detecting limit switch 22C varies depending on the lateral positional relationship between the coupling pin 21 and those limit switches, the U-shaped guide hardware 23 can improve the positioning accuracy between the coupling pin 21 and the closing-position detecting limit switch 22A, disconnecting-position detecting limit switch 22B, and earthing-position detecting limit switch 22C.

As described above, the switchgear according to this embodiment can improve stopping accuracy at three positions, i.e., a closing position, a disconnecting position, and an earthing position, thereby stabilizing insulation performance.

The present invention should not be limited to the above embodiment, but includes various modifications. For example, the above embodiment is detailed descriptions for comprehensively explaining the present invention, and the invention should not necessarily be limited to include all the configurations described above. Furthermore, a part of a configuration in one embodiment can be replaced by a configuration in another embodiment, and a configuration in one embodiment can be added to a configuration in another embodiment. Apart of a configuration in each embodiment can also be added to, deleted from, or replaced by another configuration.

### REFERENCE SIGNS LIST

1: vacuum insulated switchgear; 2: mold switch; 3: operating device; 4: operating-force transmission unit; 5: vacuum interrupter; 6: air-insulated earthing disconnecting switch; 7: first fixed electrode; 8: second fixed electrode; 9: third fixed electrode; 10: busbar mold bushing; 11: fixed electrode; 12: movable electrode; 13 flexible conductor; 14: movable conductor; 15: bellows; 16: mold bushing; 17: voltage detector; 18: arc shield; 19: fixed conductor; 20: vacuum chamber; 21: coupling pin; 22A: closing-position detecting limit switch; 22B: disconnecting-position detecting limit switch; 22C: earthing-position detecting limit switch; 23: guide hardware; 23A: first slotted hole; 24A, 24B, 24C: roller; 25: motor; 25A: motor's rotating shaft; 26: operating instrument; 27: solid insulator; 33: feeder conductor; 43: air movable electrode; 50: main lever; 51, 61: three-phase levers; 51A, 61A: shaft; 52, 62: air-insulated operation rod; 53, 63: operation rod; 55: operating-instrument-side rod; 61B: extended shaft; 61C: second slotted hole; 65A: first chain; 65B second chain; 66A: first gear; and 66B: second gear.

1. A switchgear comprising:
an air-insulated earthing disconnecting switch that has a movable electrode moving linearly and is switchable among a closing position, a disconnecting position, and an earthing position;
a vacuum interrupter that is electrically connected to the air-insulated earthing disconnecting switch and makes and breaks current flow in a vacuum chamber maintained under vacuum; and
an operating device of the air-insulated earthing disconnecting switch, which has a motor and provides driving force to the movable electrode of the air-insulated earthing disconnecting switch;
an operating device of the vacuum interrupter, which provides driving force to a movable electrode of the vacuum interrupter; and
an operating-force transmission unit that transmits driving force from the motor of the operating device of the air-insulated earthing disconnecting switch to the movable electrode of the air-insulated earthing disconnecting switch,
wherein the air-insulated earthing disconnecting switch and the vacuum interrupter are integrally covered with a solid insulator, and
the operating-force transmission unit includes
an operation rod fixedly coupled to the movable electrode of the air-insulated earthing disconnecting switch,
a shaft rotatably driven by the motor,
a lever fixed to the shaft and making an arc motion with the shaft rotatably driven,
a coupling pin coupling the lever and the operation rod, and
limit switches that detect that the air-insulated earthing disconnecting switch is in the closing position, disconnecting position, or earthing position by means of the coupling pin driven by the operation rod operating with an arc motion of the lever.

2. The switchgear according to claim 1,
wherein the limit switches are arranged on a U-shaped guide hardware, the U-shaped guide hardware being disposed so as to surround the coupling part where the lever and the operation rod are coupled with the coupling pin and having first slotted holes extending in the vertical direction in side walls opposite to each other, and
the coupling pin moving in the first slotted holes in the vertical direction makes contact with the limit switches arranged at positions corresponding to the closing position, disconnecting position, and earthing position of the air-insulated earthing disconnecting switch to detect that the air-insulated earthing disconnecting switch is in the closing position, disconnecting position, or earthing position.

3. The switchgear according to claim 2,
wherein the lever has an end with a second slotted hole extending in the longitudinal direction of the lever,
the coupling pin moves in the second slotted hole in synchronization with an arc motion of the lever, and
the coupling pin moving in the vertical direction in the first slotted holes causes the operation rod to move in the vertical direction.

4. The switchgear according to claim 2,
wherein the limit switches include one limit switch disposed at a position corresponding to the closing position of the air-insulated earthing disconnecting switch, one limit switch disposed at a position corresponding to the earthing position of the air-insulated earthing disconnecting switch, and two limit switches disposed at positions corresponding to the disconnecting position of the air-insulated earthing disconnecting switch,
rollers are disposed in the vicinity of the first slotted holes where the limit switches are disposed at positions corresponding to the closing, disconnecting, and earthing positions of the air-insulated earthing disconnecting switch, and
the coupling pin makes contact with the rollers that press in the limit switches at the respective positions.

5. The switchgear according to claim 3,
wherein the limit switches include one limit switch disposed at a position corresponding to the closing position of the air-insulated earthing disconnecting switch, one limit switch disposed at a position corresponding to the earthing position of the air-insulated earthing disconnecting switch, and two limit switches disposed at positions corresponding to the disconnecting position of the air-insulated earthing disconnecting switch,
rollers are disposed in the vicinity of the first slotted holes where the limit switches are disposed at positions corresponding to the closing, disconnecting, and earthing positions of the air-insulated earthing disconnecting switch, and
the coupling pin makes contact with the rollers that press in the limit switches at the respective positions.

6. The switchgear according to claim 4,
wherein the limit switch disposed corresponding to the closing position of the air-insulated earthing disconnecting switch is arranged in an upper part of the U-shaped guide hardware, the limit switches disposed corresponding to the disconnecting position of the air-insulated earthing disconnecting switch are arranged in middle parts of the U-shaped guide hardware, and the limit switch disposed corresponding to the earthing position of the air-insulated earthing disconnecting switch is arranged in a lower part of the U-shaped guide hardware.

7. The switchgear according to claim 5,
wherein the limit switch disposed corresponding to the closing position of the air-insulated earthing disconnecting switch is arranged in an upper part of the U-shaped guide hardware, the limit switches disposed corresponding to the disconnecting position of the air-insulated earthing disconnecting switch are arranged in middle parts of the U-shaped guide hardware, and the limit switch disposed corresponding to the earthing position of the air-insulated earthing disconnecting switch is arranged in a lower part of the U-shaped guide hardware.

8. The switchgear according to claim 1,
wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.

9. The switchgear according to claim 2,
wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.

10. The switchgear according to claim 3,
wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.

11. The switchgear according to claim 4,
wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.

12. The switchgear according to claim 5, wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.

13. The switchgear according to claim 6,
wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.

14. The switchgear according to claim 7,
wherein the air-insulated earthing disconnecting switch includes a bushing-side fixed electrode connected to a busbar side conductor, an intermediate fixed electrode connected to the vacuum interrupter, an earth-side fixed electrode that is at the ground potential, and a movable electrode that makes contact with the respective fixed electrodes, and
each of the fixed electrodes is arrange linearly in the air-insulated earthing disconnecting switch, the movable electrode enters a closed state electrically continued to the busbar side conductor when making contact with the bushing-side fixed electrode, the movable electrode enters a disconnected state when the movable electrode is in a position where the distance between the movable electrode and the bushing-side fixed electrode is greater than the distance between the movable electrode and the earth-side fixed electrode, and the movable electrode is at the ground potential when making contact with the earth-side fixed electrode.
